(19) United States
(12) Patent Application Publication
(10) Pub. No.: US 2026/0281026 A1
(43) Pub. Date: Sep. 17, 2026

(54) PROVIDING VOICE AND DATA FAILOVER VIA A COMMUNICATION STREAM

(71) Applicant: LBiSat LLC, Eagle Mountain, UT (US)

(72) Inventor: Ryan Dale CONKLIN, Orem, UT (US)

(21) Appl. No.: 19/081,373

(22) Filed: Mar. 17, 2025

(51) Int. Cl. H04L 45/00; H04B 7/185; H04W 40/28; H04W 40/36

(52) U.S. Cl. CPC H04L 45/22; H04B 7/18584; H04W 40/28; H04W 40/36

(57) ABSTRACT

The present disclosure generally relates to systems, methods, and computer-readable media that provide a non-terrestrial infrastructure that supports multiple connectivity paths for multiple data communication types during a failover event. For example, the systems, methods, and computer-readable media disclosed herein provides a failover communications infrastructure for IP-based Internet data and voice communications. As such, the systems, methods, and computer-readable media disclosed herein provide a broad spectrum of non-terrestrial connectivity within a redundant communications infrastructure in the event of a communication infrastructure failure or disruption.

### BACKGROUND

Modern communications infrastructures have evolved over time. Where each communication method previously had its own network or infrastructure, modern communications systems are generally consolidated into largely terrestrial—or ground-based—copper and fiber-optic networks. This often means that a disruption in a user's Internet service, for example, frequently results in the user losing phone service as well. As such, the user is left with no connectivity for data and voice communications. This occurs in both residential and commercial settings.

Existing failover solutions for such disruptions are typically limited to specific data types and paths. For example, existing failover systems may be specific to a particular data type, like voice data. Other existing failover systems may be specific to a particular data path, like a cellular data path. Thus, regaining full connectivity in a failover situation often requires configuring multiple systems and backups.

The subject matter in the background section is intended to provide an overview of the overall context for the subject matter disclosed herein. The subject matter discussed in the background section should not be assumed to be prior art merely as a result of its mention in the background section. Similarly, a problem mentioned in the background section or associated with the subject matter of the background section should not be assumed to have been previously recognized in the prior art.

### BRIEF DESCRIPTION OF THE DRAWINGS

FIG. 1 illustrates an example overview of an environment where a dual failover system provides a complete failover communication solution between a carrier facility and a customer facility in accordance with one or more embodiments.

FIG. 2 illustrates an example configuration of the dual failover system in accordance with one or more embodiments.

FIG. 3 illustrates another example configuration of the dual failover system in accordance with one or more embodiments.

FIG. 4 illustrates a block diagram of the dual failover system controller of the dual failover system in accordance with one or more embodiments.

FIG. 5 illustrates a series of steps taken by the dual failover system in providing failover services for both data communications and voice communications during a primary service disruption in accordance with one or more embodiments.

FIG. 6 illustrates certain components that may be included within a computer system in accordance with one or more embodiments.

### DETAILED DESCRIPTION

The present disclosure relates to systems, methods, and computer-readable media that provide a non-terrestrial infrastructure that supports, in some embodiments, multiple connectivity paths for multiple data communication types. For example, a dual failover system disclosed herein may provide a failover communications infrastructure for IP-based Internet data as well as voice communications. As discussed above, while existing failover systems are typically limited to only one data type or path at a time, the dual failover system may combine satellite and/or cellular Internet connectivity via a single data receiver. This combination may provide a broad spectrum of non-terrestrial connectivity within a redundant communications infrastructure. By combining, for example, satellite network connectivity, cellular data, voice connectivity, as well as real-time communication protocols and legacy voice connectivity into one platform, the dual failover system can provide a seamless redundant infrastructure that activates in the event of a communication infrastructure failure or disruption. Such a communication infrastructure failure may be in connection with a ground-based infrastructure failure (e.g., in the event of new construction accidentally severing a buried cable). Additionally, communication infrastructure failures or disruptions may occur in response to cyber attacks, denial of server (DoS) attacks, and so forth.

In one or more embodiments, the dual failover system improves computing systems in various ways. For example, the dual failover system improves the flexibility of conventional systems by providing a failover solution that includes both voice and data communications. As mentioned above, conventional systems are typically limited to one type of failover communication at a time. As such, users are forced to put a total failover solution together piecemeal. Conversely, the dual failover system provides a failover solution that may flexibly support both data and voice communication types.

The flexibility of the dual failover system further improves the efficiency of conventional failover systems. For example, a manually pieced-together failover solution often features duplicated hardware setups to receive multiple types of failover communications. As such, computational waste is often generated as multiple sets of hardware perform communication tasks in parallel. This duplication often extends to duplicated processes and documentation.

Conversely, the dual failover system eliminates duplicated hardware and processes by providing a simplified and streamlined failover solution. For example, as mentioned above and as will be discussed in greater detail below, the dual failover system receives a (e.g., single) failover communication stream of both voice and data communications and then parses these communications out along separate data paths. As such, and based on customer configurations, the dual failover system is highly customizable and offers instantaneous backup support in the event of a primary provider service disruption.

In one or more implementations, the methods and systems performed by the dual failover system reference multiple terms. For example, as referenced herein, “failover communications” refer to a backup system of data and voice communications that activate in response to a primary service disruption to ensure continuous operation while minimizing downtime.

As referenced herein, a “service provider” refers to a company or organization that offers services to business or individuals. For example, a service provider can provide phone services to customers. Similarly, a data provider (e.g., an internet service provider or ISP) provides data services and connectivity to customers.

As used herein, the term “terrestrial services” refers to a carrier or internet service provider services who's customers last mile is transmitted over physical wires (e.g., fiber optic cables, coaxial cables, etc.) that are typically buried underground. It follows that the term “non-terrestrial services” refer to services that are transmitted wirelessly—often via a satellite network. In one or more embodiments, terrestrial phone services generally refer to traditional landline telephone or T1/PRI trunk services. Additionally, in one or more embodiments, terrestrial internet services generally refer to a data infrastructure of physical connections, such as DSL, cable, or fiber optic networks.

As used herein, a “communication failover plan” refers to a set of protocols and instructions that are preconfigured for activation in the event of a primary service disruption. In one or more embodiments, a communication failover plan can be customized to an individual customer facility or group of facilities.

As used herein, a “data receiver” refers to a device that receives and transmits data communications over a network. In one or more embodiments, a data receiver can be a router. For example, a router can be a networking device that directs data packets between computers and other devices on a network. In at least one embodiment, a data receiver can receive a single data stream. In additional embodiments, a data receiver can receive multiple data streams, such as with a dual wide area network (WAN) router or modem. For example, the multiple data streams may represent a single communication stream comprising failover voice communications and failover data communications that are transmitted through a combination of the multiple data streams and received at the data receiver. In some embodiments, a data receiver can receive voice communications and/or data communications from a satellite antenna. In additional embodiments, a data receiver can receive communications from a cellular 5G connection, a DSL fiber connection, and so forth.

As used herein, a “communication stream” refers to a flow of data that is generated and transmitted. In one or more embodiments, a communication stream refers to a data stream or single data stream that is generated and transmitted and which originates and/or arrives as a single continuous stream. As used herein, a communication stream can include a single data stream including a combination of data communications and voice communications. Additionally or alternatively, a communication stream can include a bonded stream including multiple individual streams of data communications and voice communication that arrive at a single destination. For example, the communication stream may originate and/or arrive as a single continuous stream and at a same location, but may travel as multiple streams and through multiple diverse and/or discrete paths In yet further additional or alternative embodiments, a communication stream can include multiple individual streams which collectively include a combination of data communications and voice communications. In one or more embodiments, a communication data stream refers to a data stream that is generated and transmitted in real-time.

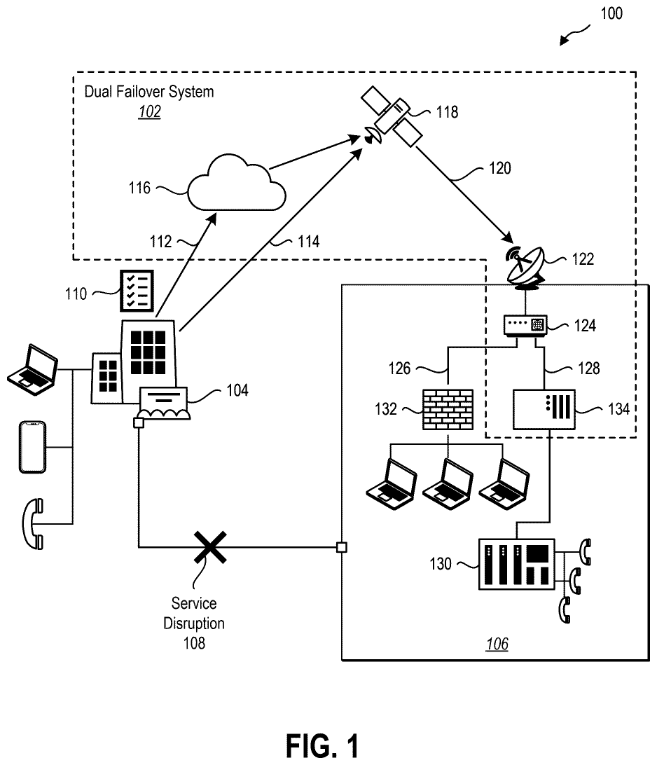

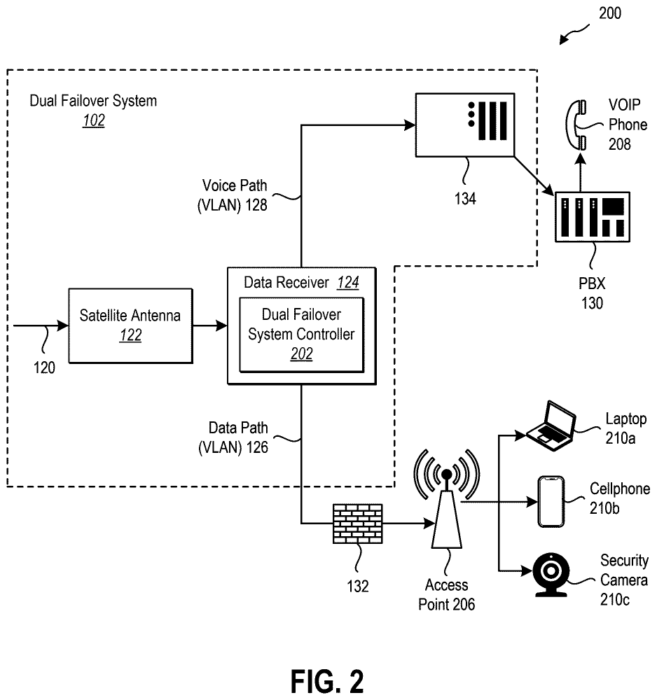

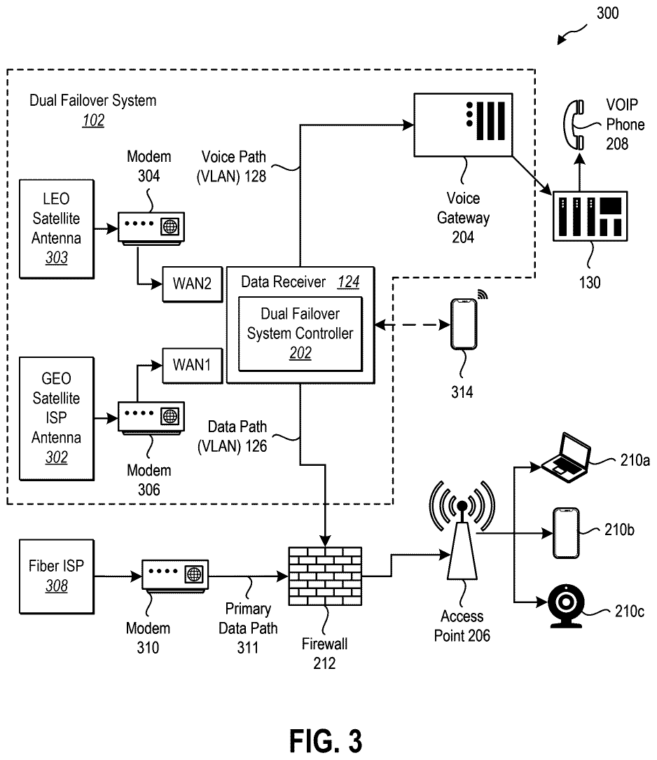

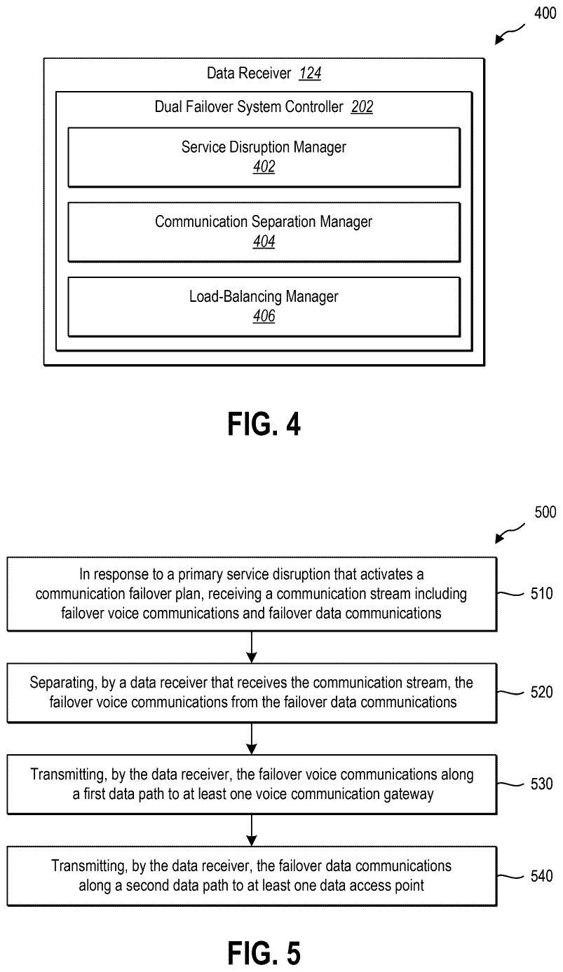

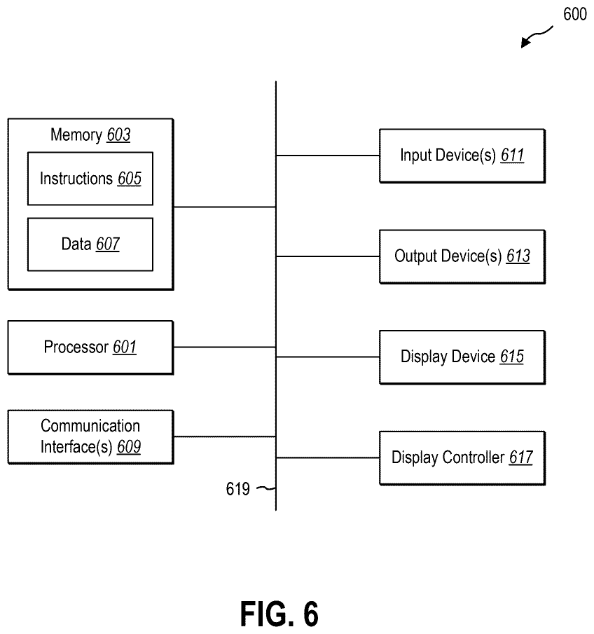

Additional details regarding example implementations of the dual failover system will now be discussed in connection with the following figures. To illustrate, FIG. 1 provides an example overview of an environment where a dual failover system provides a complete failover communication solution between a carrier facility and a customer facility. FIGS. 2 and 3 provide additional detail with regard to a dual failover system controller that operates within a data receiver at the customer facility to separate failover voice communications and failover data communications following disruption of terrestrial-based voice and/or data services. FIG. 4 provides additional detail with regard to the dual failover system controller of the dual failover system. FIG. 5 illustrates a series of steps in providing failover voice and data communications. Finally, FIG. 6 illustrates an overview diagram of a computing system.

As just mentioned, FIG. 1 illustrates an example overview of an environment 100 including a carrier facility 104 and a customer facility 106. In one or more embodiments, the carrier facility 104 may provide data communications (e.g., Internet connectivity) and voice communications (e.g., one or more telephone lines) to the customer facility 106 via terrestrial or ground-based connection 108. For example, the terrestrial or ground-based connection 108 can include copper wires, fiber optic cables, etc.

As mentioned above, the customer facility 106 may periodically experience service disruptions associated with the data or voice communications provided by the carrier facility 104. Often, when a disruption is experienced in one type of communication, both types of communications will be affected. Thus, the customer facility 106 is left with no communication options in this scenario.

In one or more embodiments, as mentioned above, the dual failover system 102 can provide failover options that combine both data and voice communications. For example, as further shown in FIG. 1, in the event of a service disruption in the terrestrial connection 108, the dual failover system 102 can activate (e.g., operate in accordance with) a communication failover plan 110 at the carrier facility 104 that is specific to the customer facility 106. In at least one embodiment, the communication failover plan 110 can cause the carrier facility 104 to transmit failover voice communications 112 and failover data communications 114 through a non-terrestrial failover network. For example, the non-terrestrial failover network can include a cloud-based infrastructure 116 for telecommunications as well as one or more satellites 118. In at least one embodiment, the one or more satellites 118 combine the failover voice communications 112 from the cloud-based infrastructure 116 and the failover data communications 114 (e.g., received via a cellular data network) into a communication stream 120.

As further shown in FIG. 1, the dual failover system 102 may further include a satellite antenna 122 at the customer facility 106 that receives the communication stream 120. In some cases, the satellite antenna 122 is a single satellite antenna that receives the communication stream 120, or may be multiple satellite antennas (or other receivers) which receive the communication stream 120 from multiple sources. In at least one embodiment, the dual failover system 102 also includes a data receiver 124 that receives the communication stream 120 from the satellite antenna 122. For example, the data receiver 124 can separate or parse the communication stream 120 along a data communication path 126 and a voice communication path 128, respectively. In some embodiments, the data communication path 126 can include a firewall 132 followed by a data access point such as a wireless router that services one or more computing devices such as laptops, security cameras, smartphones, etc. Additionally, the voice communication path 128 can include at least one voice communication gateway 134 such as a voice communications gateway that services a customer phone system (PBX) 130 followed by one or more voice communication lines/devices.

While FIG. 1 illustrate one arrangement of components in the environment 100, other arrangements and configurations are possible. For example, while FIG. 1 illustrates a single satellite 118, in an additional embodiment, the one or more satellites 118 may refer to a system including multiple receivers, such as multiple satellites, cellular infrastructure, or a mixed system of both. For example, multiple receivers may each communicate different portions of data (e.g., failover voice communications and/or failover data communications) within the communication stream 120. Two or more receivers may communicate with the same satellite antenna 122 (or other type of receiver) or the satellite antenna 122 may represent multiple antennas and/or receivers for communicating with various receivers of the one or more satellites 118. Moreover, two or more receivers of the one or more satellites 118 may communicate different portions of the same communication stream 120 where discrete portions of the same voice communications and/or data communications are carried by different receivers within the system of receivers (e.g., satellites). For example, where the communication stream 120 includes voice communication and data communications, a first portion of the voice communications and of the data communications may be carried by a first receiver (e.g., a first satellite), and a second portion of the voice communications and of the data communications may be carried by a second receiver (e.g., a second satellite). In other examples, the voice communications may be carried by a first receiver and the data communications may be carried by a second receiver. The one or more satellites 118 in this way may facilitate load balancing, redundancy, and other latency and bandwidth considerations of the dual failover system as described herein. More detail regarding the multiple-receiver functionality of the environments 100 is shown and described in connection with FIG. 3 below.

Moreover, while FIG. 1 illustrates the data receiver 124 receiving a single communication stream 120, other arrangements are also possible. For example, as will be discussed in greater detail below in connection with FIG. 3, the data receiver 124 can receive a single communication stream or multiple communication streams. In one or more embodiments, the data receiver 124 can include two or more antennas (e.g., such as with a dual WAN receiver) that each receive a single communication stream, a bonded communication stream, or otherwise multiple communication streams.

FIG. 2 illustrates a schematic diagram 200 of the dual failover system 102 operating at a customer facility (e.g., such as the customer facility 106 shown in FIG. 1). For example, as discussed above, the satellite antenna 122 receives the communication stream 120 from the one or more satellites 118. In one or more embodiments, the satellite antenna 122 transmits the communication stream 120 to the data receiver 124 including a dual failover system controller 202. In additional embodiments (not shown), the data receiver 124 can receive the communication stream 120 from a source other than an antenna.

In at least one embodiment, the dual failover system controller 202 separates failover data communications (e.g., such as the failover data communications 114 shown in FIG. 1) from failover voice communications (e.g., such as the failover voice communications 112 shown in FIG. 1) within the communication stream 120. For example, the dual failover system controller 202 can separate the failover data communications from the failover voice communications by determining a data type or destination associated with each communication in the communication stream 120. In one or more embodiments, the dual failover system controller 202 can make this determination based on metadata associated with each communication (e.g., header information). Additionally, or alternatively, the dual failover system controller 202 can make this determination based on a destination address associated with each communication in the communication stream 120.

As the dual failover system controller 202 separates the failover data communications from the failover voice communications, the dual failover system controller 202 further transmits the now-separated communications along separate paths. For example, as shown in FIG. 2, the dual failover system controller 202 can transmit the failover voice communications along a voice communication path 128 within the customer facility. The dual failover system controller 202 can further transmit the failover data communications along a data communication path 126 within the customer facility.

In one or more embodiments, both of the data communication path 126 and the voice communication path 128 can be segregated into virtual local area networks (VLANs) configured within the dual failover system controller 202. For example, the dual failover system 102 can utilize VLANs for organizational, performance, and security purposes. To illustrate, the use of separate VLANs limits the ability of devices on each VLAN from communication with each other. As such, a performance issue, security problem, or outage on one VLAN would not affect the other VLAN.

As further shown in FIG. 2, the voice communication path 128 can lead to a voice communication gateway 134. In one or more embodiments, the voice communication gateway 134 can include a computing device that filters, transmits, encodes, or decodes voice communication data according to one or more protocols. For example, the voice communication gateway 134 can operate according to voice communication protocols including SIP, PRI, T1, legacy analog protocols, and so forth. The voice communication gateway 134 can further transmit the voice communications to a customer phone system (PBX) 130 followed by a voice device such as a VoIP phone 208.

Additionally, as shown in FIG. 2, the dual failover system controller 202 can transmit the failover data communications 114 along the data communication path 126 to a firewall 132 followed by an access point 206. For example, the access point 206 can include a data communications device such as a wireless router. The access point 206 can further transmit the data communications to various wireless computing devices 210a, 210b, and 210c (e.g., including a laptop, a cell phone, a security camera).

In one or more embodiments, the dual failover system 102 can include different and/or additional components beyond what is shown in FIG. 2. For example, FIG. 3 illustrates an environment 300 including the dual failover system 102 operating in connection with such additional components. As shown in FIG. 3, the data receiver 124 can be a dual wide area network (WAN) router. As such, the data receiver 124 can connect to two separate network connections such as a single low earth orbit (LEO) satellite antenna 303 and a distinct geosynchronous orbit (GEO) satellite internet service provider antenna 302. In one or more embodiments, each of the LEO satellite antenna 303 and the GEO satellite ISP antenna 302 can connect to the data receiver 124 through their own modems 304, 306, respectively.

In alternative embodiments, the GEO satellite ISP antenna 302 can instead be a cellular 5G router. In that embodiment, the data receiver 124 would have the capability to support a cellular 5G SIM card allowing data to enter and exit the customer facility over the cell phone data/tower network. Accordingly, in this alternative embodiment, the modem 306 would instead be a SIM card associated with the cellular 5G provider. Regardless on the type of WAN or WANs attached to the data receiver 124, the data receiver 124 is flexible enough to take any type of input—thereby increasing overall redundancy.

Moreover, as further shown in FIG. 3, the environment 300 can further include the firewall 212 where the data communication path 126 terminates prior to reaching the access point 206. In further detail, the dual failover system 102 can function in connection with a firewall, such as the firewall 212, that selectively allows connectivity to the access point 206. For example, the firewall 212 can receive data connections via the secondary data path such as the data communication path 126 and an additional data connection such as a primary data path 311 from a primary data provider, such as fiber Internet service provider (ISP) connection 308, via a dedicated modem 310.

In one or more embodiments, the firewall 212 is configurable to designate the data communication path 126 as a secondary or failover route for data traffic leaving the customer facility. For example, the firewall 212 may include features that allow the firewall 212 to monitor the network connectivity of its own WAN connections. As such, the dual failover system 102 provides a secondary or redundant WAN that the firewall 212 can pipe data traffic through in the event that the primary data path 311 experiences an outage. The configuration of the firewall 212 may be specified as part of the communication failover plan of the dual failover system 102.

In a configuration such as shown in FIG. 3, the dual failover system controller 202 within the data receiver 124 can perform various functions beyond separating failover voice communications 112 from failover data communications 114. For example, when connected to two or more inputs (e.g., such as the LEO satellite antenna 303 and the GEO satellite ISP antenna 302), the dual failover system controller 202 can perform load-balancing between the two or more inputs. To illustrate, the dual failover system controller 202 can perform load balancing according to preconfigured settings that ensure a certain amount of bandwidth is reserved for voice communications or data communications. In other embodiments, load balancing may involve prioritizing certain communications of the voice communications and/or data communications based on available bandwidth. In some cases, when connected to two or more inputs, (e.g., such as the LEO satellite antenna 303 and the GEO satellite ISP antenna 302), the dual failover system controller 202 can communicate the (e.g., single) communication stream over the various inputs, for example, by directing discrete portions of the communication stream over discrete inputs. For example, the multiple inputs may be bonded, linked, or aggregated (e.g., network bonding) to provide the communication stream through multiple interfaces/inputs, such as the LEO satellite antenna 303 and the GEO satellite ISP antenna 302.

Moreover, the data receiver 124 can load balance between multiple inputs for the purpose of providing redundant infrastructure for data and voice. The segmentation or parsing of traffic also allows for independent recovery of voice and data services. For example, the dual failover system 102 can recover data services separately from voice services, and vice versa. As such, the dual failover system 102 manages recovery with greater ease and flexibility.

As further shown in FIG. 3, in some embodiments, the data receiver 124 may be operably connected to a cellular network extender 314. In one or more embodiments, and in addition to the WANs already connected to the data receiver 124, the data receiver 124 can broadcast a signal to a cellular network via the cellular network extender 314. This could provide localized cellular coverage within a customer facility that would allow users'cell phones to connect to the cellular network via either the LEO satellite antenna 303 or the GEO satellite ISP antenna 302.

As such, the data receiver 124 shown in the embodiment illustrated in FIG. 3 (e.g., a dual WAN router) can receive one or more combined data and voice communication streams via one or both of the LEO satellite antenna 303 and the GEO satellite ISP antenna 302. Accordingly, in one or more embodiments, the dual failover system controller 202 can then parse multiple combined data and voice communication streams and route the parsed voice communications and data communications along the separate paths 126, 128. It follows that the dual failover system controller 202 provides additional security as well as expanded functionality and redundancy in connection with these multiple combined communication streams. It will be noted that while FIG. 3 includes the data receiver 124 as a dual WAN router, the data receiver 124 illustrated in connection with other embodiments may also be a dual WAN router. For example, in at least one embodiment, the data receiver 124 illustrated in connection with the embodiment shown in FIG. 1 may include a dual WAN router for connecting to multiple inputs and/or antennas.

While the details discussed herein in connection with the embodiments above (e.g., the embodiments illustrated in connection with FIGS. 1, 2, and 3) are primarily centered on the receiving capabilities of the data receiver 124 and the dual failover system controller 202, it will be understood that the dual failover system 102 can also transmit data from the data receiver 124 and dual failover system controller 202. For example, the dual failover system controller 202 can collect data communications and/or voice communications from any of one or more VoIP phones 208, the various wireless computing devices 210a-210c, cellular network devices, and so forth.

Upon receipt of communications from any device within the customer facility, the dual failover system controller 202 can package, bundle, packet-ize, or otherwise parse the communications for transmissions from the customer facility via one or more communication streams. For example, the dual failover system controller 202 can transmit the communications via one or more antennas included as part of the data receiver 124 over one or more communication streams 120. As discussed above, these communication streams may be communicated over one or more satellites 118 (e.g., including a single satellite or a system of multiple satellites) to one or more endpoints (e.g., the carrier facility 104 or other destinations).

As mentioned above, the dual failover system 102 provides a combination of both failover voice communications and failover data communications in the event of a terrestrial-based primary service disruption. FIG. 4 is a block diagram 400 of the dual failover system controller 202 operating within the data receiver 124 as part of the dual failover system 102. As such, FIG. 4 provides additional detail with regard to how the dual failover system controller 202 performs various functions as part of the dual failover system 102. For example, as shown in FIG. 4, the dual failover system 102 can include a service disruption manager 402, a communication separation manager 404, and a load-balancing manager 406.

In certain implementations, the dual failover system controller 202 of the dual failover system 102 may represent one or more software applications, modules, or programs that, when executed by a computing device, may cause the computing device to perform one or more tasks. For example, and as will be described in greater detail below, one or more of the service disruption manager 402, the communication separation manager 404, or the load-balancing manager 406 may represent software stored and configured to run on one or more computing devices. Similarly, one or more of the service disruption manager 402, the communication separation manager 404, or the load-balancing manager 406 may represent software stored and configured to run on one or more computing devices, such as the data receiver 124. Any of the service disruption manager 402, the communication separation manager 404, and/or the load-balancing manager 406 in FIG. 4 may also represent all or portions of one or more special purpose computers to perform one or more operations.

As mentioned above, and as shown in FIG. 4, the dual failover system controller 202 of the dual failover system 102 includes the service disruption manager 402. In one or more embodiments, the service disruption manager 402 detects and monitors interruptions and other issues in connection with one or more WANs connected to the data receiver 124 (e.g., the LEO satellite antenna 303 and the satellite internet service provider antenna 302 shown in FIG. 3).

For example, the service disruption manager 402 can detect and send notifications associated with status changes of one or more WANs connected to the data receiver 124. In one or more embodiments, WAN connections from a satellite (e.g., such as WAN connections received via the LEO satellite antenna 303 and/or the satellite internet service provider antenna 302) may always be live. The dual failover system 102 can then utilize those connections in response to receiving outage data from the carrier facility 104. Similarly, for outbound communications from the customer facility, the firewall 212 can utilize the data communication path 126 in response to a detected outage. In that case, the service disruption manager 402 can detect the flow of communication over the data communication path 126 to determine that the communication failover plan has been activated.

In one or more embodiments, the service disruption manager 402 can determine when a primary service disruption has ended. For example, the service disruption manager 402 can determine that the primary service disruption has ended in response determining that communications are no longer flowing over either or both of the data communication path 126 and the voice communication path 128.

As mentioned above, and as shown in FIG. 4, the dual failover system controller 202 of the dual failover system 102 includes the communication separation manager 404. In one or more embodiments, the communication separation manager 404 separates failover voice communications from failover data communication that are received by the one or more antennas connected to the data receiver 124 during a primary service disruption.

The communication separation manager 404 can separate different types of failover communications based on different criteria. For example, in one embodiment, the communication separation manager 404 separates failover communications based on data types. To illustrate, the communication separation manager 404 can determine a data type associated with each failover communication received by the data receiver 124. The communication separation manager 404 can then transmit the failover communications along either of the data communication path 126 or the voice communication path 128 based on the determined data types.

As mentioned above, and as shown in FIG. 4, the dual failover system controller 202 of the dual failover system 102 includes the load-balancing manager 406. As mentioned above, the communication failover plan can include customer-specific instructions that ensure certain services continue to perform normally even in a failover situation. As such, the load-balancing manager 406 can perform tasks associated with such instructions from the communication failover plan. For example, the load-balancing manager 406 can distribute incoming communication traffic (e.g., once the failover communications have been separated by the communication separation manager 404) to ensure that the voice communication gateway 204 and/or data access point 206 are not overwhelmed. Similarly, the load-balancing manager 406 can throttle outgoing transmissions along the data communication path 126 to ensure that adequate bandwidth remains for transmissions along the voice communication path 128, and vice versa.

In more detail, the load-balancing manager 406 can perform load balancing according to various methods. For example, the load-balancing manager 406 can perform weighted load balancing by assigning more traffic to a given WAN connection based on connection speed or based on whether a connection has a bandwidth cap. In another embodiment, the load-balancing manager 406 can perform priority load balancing where a particular WAN connection is designated as preferred, or multiple WAN connections are arranged in priority of use. In another embodiment, the load-balancing manager 406 can perform overflow load balancing where traffic slowdowns due to congestion on a particular WAN connection are prevented utilizing an order of failover when congestion occurs. In another embodiment, the load-balancing manager 406 can perform persistence load balancing by ensuring given traffic types are always routed over the same WAN connection based on source/destination IP address—thereby eliminating session termination issues with HTTPS connections. In another embodiment, the load-balancing manager 406 can perform least used load balancing that helps steer traffic to a WAN connection that is least congested. In another embodiment, the load-balancing manager 406 can perform lowest latency load balancing that uses the fastest WAN connection based on the latency time of the second or third hops of traffic using a given WAN link. In another embodiment, the load-balancing manager 406 can perform enforced load balancing by restricting traffic to a particular WAN connection. Finally, in another embodiment, the load-balancing manager 406 can perform fastest response time load balancing that uses the fasted connection based on session response times from the traffic destination.

In one or more embodiments, the data receiver 124 can include one or more memories. For example, the one or more memories can generally represent any type or form of volatile or non-volatile storage device or medium capable of storing data and/or computer-readable instructions. In one example, the one or more memories may store, load, and/or maintain one or more components of the dual failover system controller 202 of the dual failover system 102. Examples of the one or more memories can include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, and/or any other suitable storage memory.

Moreover, in one or more embodiments, the data receiver 124 can include one or more physical processors. The one or more processor(s) generally represent any type or form of hardware-implemented processing units capable of interpreting and/or executing computer-readable instructions. In one implementation, the one or more physical processors may access and/or modify one or more components of the dual failover system controller 202 of the dual failover system 102. Examples of the one or more physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

As discussed above, the dual failover system 102 provides failover services for both data communications and voice communications during a primary service disruption. FIG. 5 illustrates an example series of acts for providing failover voice and data communications. While FIG. 5 illustrates acts according to one or more embodiments, alternative embodiments may omit, add to, reorder, and/or modify any of the acts shown in FIG. 5. The acts of FIG. 5 can be performed as part of a method. Alternatively, a non-transitory computer-readable medium can include instructions that, when executed by one or more processors, cause a computing device to perform the acts of FIG. 5. In still further embodiments, a system can perform the acts of FIG. 5.

As further illustrated in FIG. 5, the series of acts 500 includes an act 510 of, in response to a primary service disruption that activates a communication failover plan, receiving a communication stream including failover voice communications and failover data communications. In one or more embodiments, the communication failover plan includes failover instructions that prompt the service provider site to provide failover voice communications and failover data communications over a non-terrestrial satellite network and that prompt the data receiver to receive the failover voice communications and failover data communications in the communication stream. In at least one embodiment, the primary service disruption is a disruption in at least one of terrestrial internet services or terrestrial phone services. For example, the series of acts 500 can further include, prior to receiving the communication stream, receiving voice communications via a terrestrial phone service pathway and receiving data communications via a terrestrial internet service pathway.

As further illustrated in FIG. 5, the series of acts 500 includes an act 520 of separating, by a data receiver that receives the communication stream, the failover voice communications from the failover data communications. For example, the data receiver can separate the failover voice communications from the failover data communications by determining a data type associated with each received communication, and directing each received communication along the first data path or the second data path based on the data type.

As further illustrated in FIG. 5, the series of acts 500 includes an act 530 of transmitting, by the data receiver, the failover voice communications along a first data path to at least one voice communication gateway. Additionally, as illustrated in FIG. 5, the series of acts 500 includes an act 540 of transmitting, by the data receiver, the failover data communications along a second data path to at least one data access point. In one or more embodiments, the first data path and the second data path include separate VLANs.

In some embodiments, the series of acts 500 includes, prior to detecting the primary service disruption, receiving voice communications via a terrestrial phone service pathway and receiving data communications via a terrestrial internet service pathway. Additionally, in some embodiments, the series of acts 500 includes determining that the primary service disruption has ended, and transmitting a message to the service provider site according to the communication failover plan that instructs the service provider site to switch data communications to the terrestrial internet service pathway and voice communications to the terrestrial phone service pathway.

FIG. 6 illustrates certain components that may be included within a computer system 600. One or more computer systems 600 may be used to implement the various devices, components, and systems described herein.

The computer system 600 includes a processor 601. The processor 601 may be a general-purpose single-or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 601 may be referred to as a central processing unit (CPU). Although just a single processor 601 is shown in the computer system 600 of FIG. 6 in an alternative configuration, a combination of processors (e.g., an ARM and DSP) could be used.

The computer system 600 also includes memory 603 in electronic communication with the processor 601. The memory 603 may be any electronic component capable of storing electronic information. For example, the memory 603 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

Instructions 605 and data 607 may be stored in the memory 603. The instructions 605 may be executable by the processor 601 to implement some or all of the functionality disclosed herein. Executing the instructions 605 may involve the use of the data 607 that is stored in the memory 603. Any of the various examples of modules and components described herein may be implemented, partially or wholly, as instructions 605 stored in memory 603 and executed by the processor 601. Any of the various examples of data described herein may be among the data 607 that is stored in memory 603 and used during execution of the instructions 605 by the processor 601.

A computer system 600 may also include one or more communication interfaces 609 for communicating with other electronic devices. The communication interface(s) 609 may be based on wired communication technology, wireless communication technology, or both. Some examples of communication interfaces 609 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 600 may also include one or more input devices 611 and one or more output devices 613. Some examples of input devices 611 include a keyboard, mouse, microphone, remote control device, button, joystick, trackball, touchpad, and lightpen. Some examples of output devices 613 include a speaker and a printer. One specific type of output device that is typically included in a computer system 600 is a display device 615. Display devices 615 used with embodiments disclosed herein may utilize any suitable image projection technology, such as liquid crystal display (LCD), light-emitting diode (LED), gas plasma, electroluminescence, or the like. A display controller 617 may also be provided, for converting data 607 stored in the memory 603 into text, graphics, and/or moving images (as appropriate) shown on the display device 615.

The various components of the computer system 600 may be coupled together by one or more buses, which may include a power bus, a control signal bus, a status signal bus, a data bus, etc. For the sake of clarity, the various buses are illustrated in FIG. 6 as a bus system 619.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A voice and data communications failover infrastructure comprising:
a communication stream carrying a combination of failover voice communications and failover data communications;
a data receiver that receives the communication stream, the data receiver configured to separate the failover voice communications from the failover data communications in response to a detected primary service disruption;
a first data path connected to the data receiver configured to carry the failover voice communications of the communication stream to at least one voice communication gateway; and
a second data path connected to the data receiver configured to carry the failover data communications of the communication stream to at least one data access point.

2. The voice and data communications failover infrastructure as recited in claim 1, wherein the communication stream is a combination of a satellite voice data stream and a cellular data stream.

3. The voice and data communications failover infrastructure as recited in claim 1, wherein the communication stream is a combination of a satellite voice data stream and a satellite data stream.

4. The voice and data communications failover infrastructure as recited in claim 1, wherein the data receiver separates the failover voice communications from the failover data communications based on data types assigned to each of the failover voice communications and the failover data communications.

5. The voice and data communications failover infrastructure as recited in claim 1, wherein the first data path and the second data path comprise separate VLANs, and further comprising a firewall in the second data path connected to the data receiver that the failover data communications pass through prior to arriving at the at least one data access point.

6. The voice and data communications failover infrastructure as recited in claim 1, wherein the data receiver further receives a second data stream.

7. The voice and data communications failover infrastructure as recited in claim 6, wherein the router performs load balancing between the communication stream and the second data stream.

8. A voice and data communications failover infrastructure comprising:
a first data stream carrying a first combination of failover voice communications and failover data communications;
a second data stream carrying a second combination of failover voice communications and failover data communications;
a dual WAN router that receives the first data stream and the second data stream, the dual WAN router configured to parse failover voice communications and failover data communications within the first data stream and the second data stream;
a first data path connected to the dual WAN router configured to carry parsed failover voice communications of the first data stream and the second data stream to at least one voice communication gateway; and
a second data path connected to the dual WAN router configured to carry parsed failover data communications of the first data stream and the second data stream to at least one data access point.

9. The voice and data communications failover infrastructure as recited in claim 8, wherein the first data stream is a combination of a satellite voice data stream and a cellular data stream.

10. The voice and data communications failover infrastructure as recited in claim 9, wherein the second data stream is a combination of a satellite voice data stream and a satellite data stream.

11. The voice and data communications failover infrastructure as recited in claim 8, wherein the dual WAN router separates the failover voice communications from the failover data communications based on data types assigned to each of the failover voice communications and the failover data communications.

12. The voice and data communications failover infrastructure as recited in claim 8, wherein the first data path and the second data path comprise separate VLANs.

13. The voice and data communications failover infrastructure as recited in claim 8, further comprising a firewall in the second data path connected to the dual WAN router that the failover data communications pass through prior to arriving at the at least one data access point.

14. The voice and data communications failover infrastructure as recited in claim 8, wherein the dual WAN router performs load balancing between the first data stream and the second data stream.

15. A method for providing failover voice and data communications comprising:
in response to a primary service disruption that activates a communication failover plan, receiving a communication stream comprising a combination of failover voice communications and failover data communications;
separating, by a data receiver that receives the communication stream, the failover voice communications from the failover data communications;
transmitting, by the data receiver, the failover voice communications of the communication stream along a first data path to at least one voice communication gateway; and
transmitting, by the data receiver, the failover data communications of the communication stream along a second data path to at least one data access point.

16. The method as recited in claim 15, wherein the communication failover plan comprises failover instructions that prompt the service provider site to provide failover voice communications and failover data communications over a non-terrestrial satellite network and that prompt the data receiver to receive the failover voice communications and failover data communications in the communication stream.

17. The method as recited in claim 16, wherein the primary service disruption is a disruption in at least one of terrestrial internet services or terrestrial phone services.

18. The method as recited in claim 17, further comprising, prior to receiving the communication stream, receiving voice communications via a terrestrial phone service pathway and receiving data communications via a terrestrial internet service pathway.

19. The method as recited in claim 15, wherein the data receiver separates the failover voice communications from the failover data communications by:
determining a data type associated with each received communication; and
directing each received communication along the first data path or the second data path based on the data type.

20. The method as recited in claim 15, wherein the first data path and the second data path comprise separate VLANs.
